(19) United States
(12) Patent Application Publication
(10) Pub. No.: US 2006/0209757 A1
(43) Pub. Date: Sep. 21, 2006

(54) Method and apparatus for providing fast handoff in a radio communication system

(76) Inventor: Liangchi Hsu, San Diego, CA (US)

Correspondence Address: DITTHAVONG & CARLSON, P.C., Suite A, 10507 Braddock Road, Fairfax, VA, 22032, US

(21) Appl. No.: 11/078,162

(22) Filed: Mar. 11, 2005

(51) Int. Cl. H04Q 7/00

(52) U.S. Cl. 370/331

(57) ABSTRACT

An approach is provided for executing a fast handoff in a radio communication system. An active hard handoff condition associated with a communication session supported by a radio link protocol (RLP) flow and a signaling link protocol (SLP) flow is detected. Transfer of state information and data of the RLP and the SLP is performed over a pre-designated interface from a source entity to a target entity if an active hard handoff condition is detected. The above process is particularly suitable for deployment in radio communication systems, such as a cellular system.

### FIELD OF THE INVENTION

The present invention relates to communications, and more particularly, to providing handoff in a radio communication system.

### BACKGROUND OF THE INVENTION

Radio communication systems provide users with the convenience of mobility along with a rich set of services and features. With the vast and rapid adoption of these services, standardization efforts have increased to ensure interoperability as well as provide an evolutionary path to new services and associated infrastructure. One such new service aims to provide increased capacity to support, for instance, a high-rate data service. The International Telecommunications Union (ITU) for International Mobile Telecommunications 2000 (IMT-2000) has made steady progress towards an Internet Protocol (IP)-based radio access network, which utilizes Access Networks (ANs) (or base stations) to serve Access Terminals (ATs) (or mobile stations). An area of interest is the manner active handoff procedures, particularly “hard” handoffs, are conducted as an AT moves from one AN to the next when an active data session is ongoing. In the case of an active hard handoff, the connection is terminated with one AN and reestablished with the next AN. During this procedure, service disruption can easily occur and be detected by the user if the active handoff is slow. Current systems do not possess a pragmatic or efficient approach to this active hard handoff procedure.

Therefore, there is a need to provide an efficient fast handoff procedure for a radio communication system that supports high-rate data services.

### SUMMARY OF THE INVENTION

These and other needs are addressed by the present invention, in which an approach provides a fast handoff in a radio communication system.

According to one aspect of an embodiment of the present invention, a method for providing a fast handoff in a radio communication system is disclosed. The method includes detecting an active hard handoff condition associated with a communication session supported by a radio link protocol (RLP) flow and a signaling link protocol (SLP) flow. The method also includes initiating transfer of state information of the RLP flow and the SLP flow over a pre-designated interface from a source entity to a target entity if an active hard handoff condition is detected.

According to another aspect of an embodiment of the present invention, a network apparatus for providing a fast handoff in a radio communication system is disclosed. The apparatus includes a logic configured to detect an active hard handoff condition associated with a communication session supported by a radio link protocol (RLP) flow and a signaling link protocol (SLP) flow. The apparatus also includes a communication interface configured to transfer state information of the RLP flow and the SLP flow over a pre-designated interface from a source entity to a target entity if an active hard handoff condition is detected.

According to another aspect of an embodiment of the present invention, a method for providing a fast handoff in a radio communication system is disclosed. The method includes means for detecting an active hard handoff condition associated with a communication session supported by a radio link protocol (RLP) flow and a signaling link protocol (SLP) flow. The method also includes means for initiating transfer of state information of the RLP flow and the SLP flow over a pre-designated interface from a source entity to a target entity if an active hard handoff condition is detected.

According to another aspect of an embodiment of the present invention, a method for providing communication signaling is disclosed. The apparatus includes means for detecting an active hard handoff condition associated with a high rate packet data (HRPD) session supported by one or more radio link protocol (RLP) flows and one or more signaling link protocol (SLP) flows. The method also includes for initiating transfer of state information of the RLP flows and the SLP flows over an A13 interface to a target entity if an active hard handoff condition is detected.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a radio communication system capable of support fast handoff between Access Networks/Packet Control Functions (ANs/PCFs), in accordance with an embodiment of the present invention;

FIG. 2 is a diagram of a source entity conveying Radio Link Protocol (RLP) and Signalling Link Protocol (SLP) state information to a target entity, in accordance with various embodiments of the present invention;

FIG. 3 is a flowchart of a handoff process, in accordance with various embodiments of the present invention;

FIGS. 4A and 4B are diagrams of a message specifying RLP state information, in accordance with various embodiments of the present invention; and

FIG. 5 is a diagram of a message specifying SLP state information, in accordance with various embodiments of the present invention; and

FIG. 6 is a diagram of hardware that can be used to implement an embodiment of the present invention.

### DESCRIPTION OF THE PREFERRED EMBODIMENT

An apparatus, method, and software for supporting fast handoff in radio communication system are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is discussed with respect to a spread spectrum system, it is recognized by one of ordinary skill in the art that the present invention has applicability to any type of radio communication system.

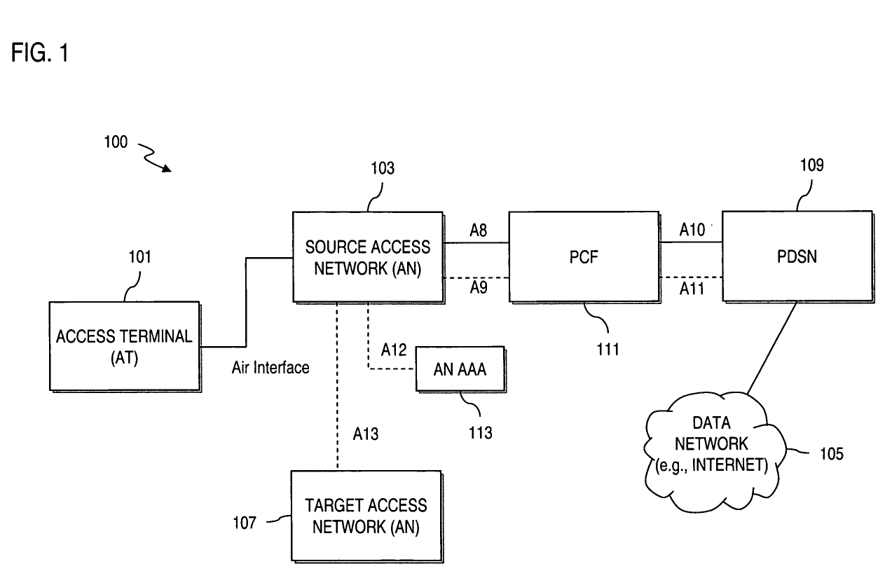

FIG. 1 is a diagram of a radio communication system capable of support fast handoff between Access Networks/Packet Control Functions (ANs/PCFs), in accordance with an embodiment of the present invention. By way of example, a radio network 100 is a 1× EV-DO (Evolutionary/Data Optimized) system according to the Third Generation Partnership Project 2 (3GPP2) standard that supports High Rate Packet Data (HRPD). The radio network 100 includes one or more access terminals (ATs) of which one AT 101 is shown in communication with an access network (AN) 103 over an air interface. The AT 101 is a device that provides data connectivity to a user. For example, the AT 101 can be connected to a computing system, such as a personal computer, a personal digital assistant, and etc. or a data service enabled cellular handset. The AN 103 is a network equipment that provides data connectivity between a packet switched data network 105, such as the global Internet and the AT 101. In cdma2000 systems, the AT 101 is equivalent to a mobile station, and the access network 103 is equivalent to a base station.

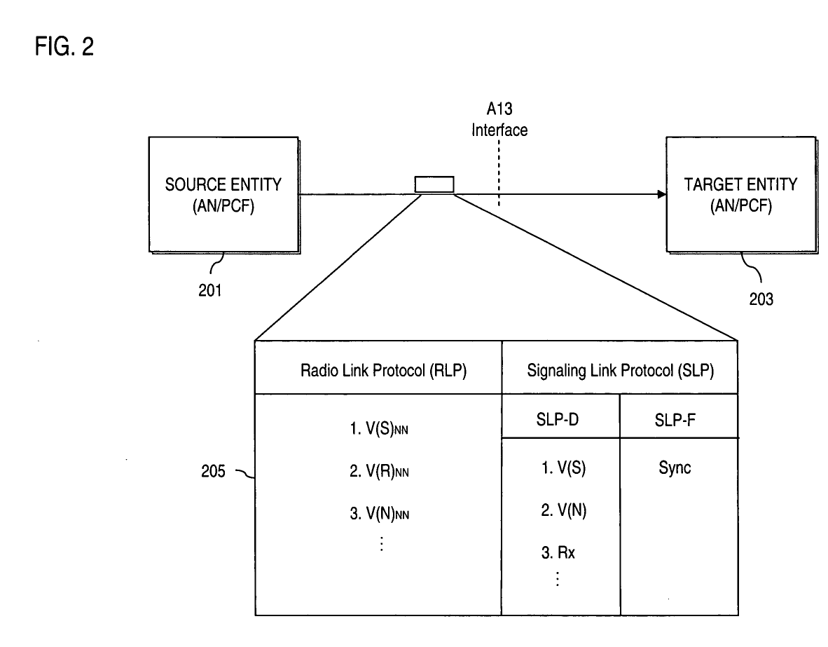

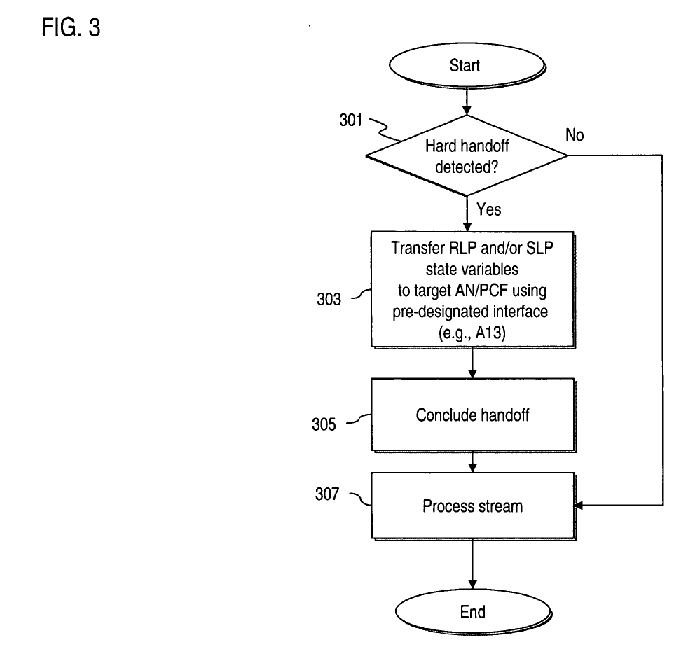

In the radio network 101, handoffs of communication sessions of the AT 101 can occur between the AN 103 and another AN 107. In this context, the AN 103 is considered the source AT, while the AN 107 is the target access network. The handoff procedure relating to an active hard handoff, whereby a communication session or connection is “broken” or terminated and reestablished between ANs 103, 107, is described later with respect to FIGS. 2 and 3.

A connection is a particular state of the air-link in which the AT 101 is assigned a Forward Traffic Channel, a Reverse Traffic Channel and associated Medium Access Control (MAC) Channels. During a single HRPD session, the AT 101 and the AN 103 can open and can close a connection multiple times. An HRPD session refers to a shared state between the AT 101 and the AN 103. This shared state stores the protocols and protocol configurations that were negotiated and are used for communications between the AT 101 and the AN 103. Other than to open a session, the AT 101 cannot communicate with the AN 101 without having an open session. A more detailed description of the HRPD is provided in 3GPP2 C.S0024 v3.0, entitled “cdma2000 High Rate Packet Data Air Interface Specification,” December 2001, 3GPP2 A.S0007-A v2.0, entitled “Interoperability Specification (IOS) for High Rate Packet Data (HRPD) Access Network Interfaces—Rev. A,” May 2003, and 3GPP2 A.S0008-0 v3.0, entitled “Interoperability Specification (IOS) for High Rate Packet Data (HRPD) Access Network Interfaces,” May 2003; which are incorporated herein by reference in their entireties.

The AN 103 communicates with a Packet Data Service Node (PDSN) 109 via a Packet Control Function (PCF) 111. Either the AN 103 or the PCF 111 provides a SC/MM (Session Control and Mobility Management) function, which among other functions includes storing of HRPD session related information, performing the terminal authentication procedure to determine whether an AT 101 should be authenticated when the AT 101 is accessing the radio network 100, and managing the location of the AT 101. The PCF 111 is further described in 3GPP2 A.S0001-A v2.0, entitled “3GPP2 Access Network Interfaces Interoperability Specification,” June 2001, which is incorporated herein by reference in its entirety.

In addition, the AN 103 communicates with an AN-AAA (Authentication, Authorization and Accounting entity) 113, which provides terminal authentication and authorization functions for the AN 103.

As shown, a variety of interfaces are utilized between different network entities. The A8 interface carries user traffic between the AN 103 and the PCF 111. An A9 interface carries signaling information between the AN 103 and the PCF 111. Similarly, between the PCF 111 and the PDSN 109 interfaces A10 and A11 are used to carry, respectively, user traffic and signaling information.

Also, the AN 103 employs the A12 interface to transport signaling information related to terminal authentication between the SC/MM function in the PCF 111 and the AN-AAA 113.

An A13 interface supports exchange of signaling information between the source AN 103 and the target AN 107. According to one embodiment of the present invention, the A13 is used to transfer SLP (signalling link protocol) state variables from a source AN/PCF (depending on 1× EV-DO radio access network architecture). In one example, the A13 interface provides a UDP port number to be used for signaling interconnection to the target AN 107. In particular, information may be exchanged in either the source to target direction or the target to source direction.

The procedure for the A13 interface is a message flow to exchange AT and PDSN information between the ANs 103 and 107. The information is exchanged via the following messages: A13-Session Information Request, A13-Session Information Response, A13-Session Information Confirm, and A13-Session Information Reject. The A13-Session Information Request message is sent by the target AN 107 to request information about an AT 101 from a source AN 103 when the target AN 107 does not have this information. The A13-Session Information Response message is used by the source AN 103 to respond to the target AN's request to retrieve information about an AT 101. When the source AN 103 receives an A13-Session Information Request message it checks if the session information for the requested AT 101 exists and if it can authenticate the target AN request. After the source AN 103 has successfully authenticated the message contained in the A13-Session Information Request message and obtained the requested session state information, it sends an A13-Session Information Response message to the target AN 107 with the requested information. The A13-Session Information Confirm message is used by the target AN 107 to inform the source AN 103 that the target AN 107 has successfully received the session information about an AT 101. The A13-Session Information Reject message is used by the source AN 103 to reject a request from the target AN 107 to retrieve session information from source AN 103.

During a handoff, the source AN 103 generates an A13-Handoff Request message to the target AN 107. The approach, according to one embodiment of the present invention, supplies Radio Link Protocol (RLP) and Signalling Link Protocol (SLP) state information via the A13-Handoff Request message.

FIG. 2 is a diagram of a source entity conveying Radio Link Protocol (RLP) and Signalling Link Protocol (SLP) state information to a target entity, in accordance with various embodiments of the present invention. It is noted that the PCF 111 can be viewed as being a part of the AN 103. Thus, for the purposes of explanation, the AN 103 and the PCF 111 considered the same entity in the context of the hard handoff procedure. That is, although not shown, the PCF 111 can also communicate with another PCF, as a target PCF. In this example, the source entity 201 seeks to handoff to a target entity 203.

It is recognized that when the inter-AN/PCF active hard handoff occurs, the buffered RLP and SLP packets in the source AN/PCF may cause service disruption if they are not appropriately transferred to the target AN/PCF. One approach would be only to transfer all the packets between AN/PCF; however, such an approach is not complete. By contrast, the system 100 provides an efficient scheme to transfer state information/variables 205 and the information data within in the buffers of RLP (for data) and SLP (for signalling) between the ANs/PCFs.

According to one embodiment of the present invention, if multiple RLP flows are used for a certain communication session corresponding to an 1× EV-DO access terminal 101 (or mobile station), for example, then all of the multiple RLP state variables and RLP packet data remained in the buffer are transferred using A13.

As seen in FIG. 2, the information 205 carried over the A13 interface can specify RLP variables and/or SLP information. RLP information includes the variables enumerated in Table 1.

TABLE 1

| NAME | DESCRIPTION |
|---|---|
| V(S)_{NN} | Sequence number of the first octet of the |
| | next RLP packet to be sent, of the RLP |
| | flow NN |
| V(R)_{NN} | Sequence number of the first octet of the |
| | next RLP packet expected to be received, |
| | of the RLP flow NN |
| V(N)_{NN} | Sequence number of the first octet of the |
| | next RLP packet needed for sequential |
| | delivery, of the RLP flow NN |

As regards the SLP state variables, two parts are defined: Signaling link protocol—Delivery layer (SLP-D) and Signaling link protocol—Fragmentation layer (SLP-F).

TABLE 2

| | |
|---|---|
| NAME | DESCRIPTION |

Signaling link protocol - Delivery layer (SLP-D)

| | |
|---|---|
| V(S) | Sequence number of the next SLP-D |
| | packet to be sent |
| V(N) | Sequence number of the next expected |
| | SLP-D packet; |
| Rx | Mapping vector of received packets |

Signaling link protocol - Fragmentation layer (SLP-F)

| | |
|---|---|
| Sync | The SLP-F synchronized status flag |

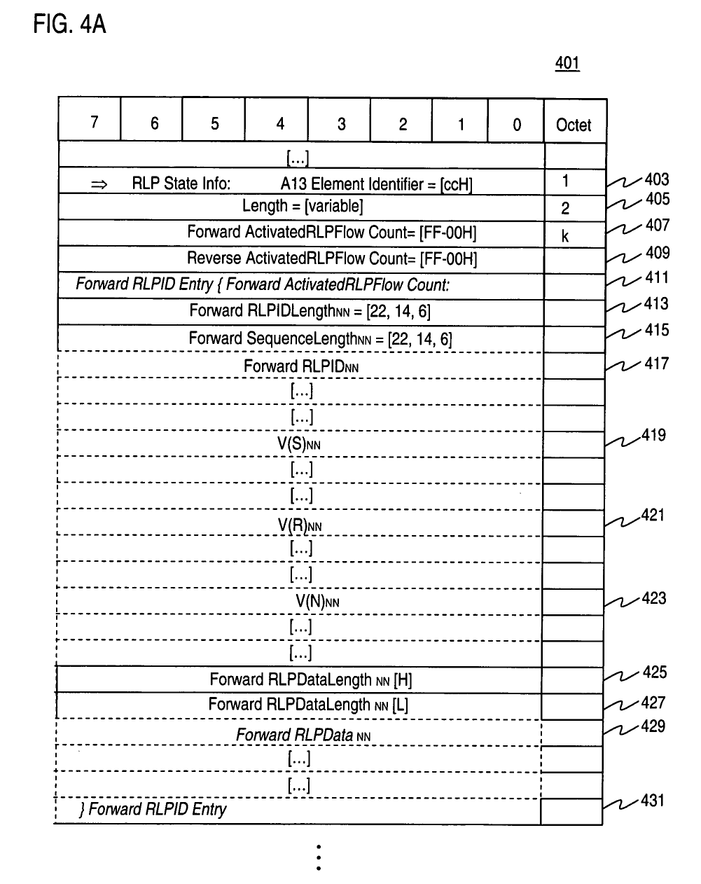

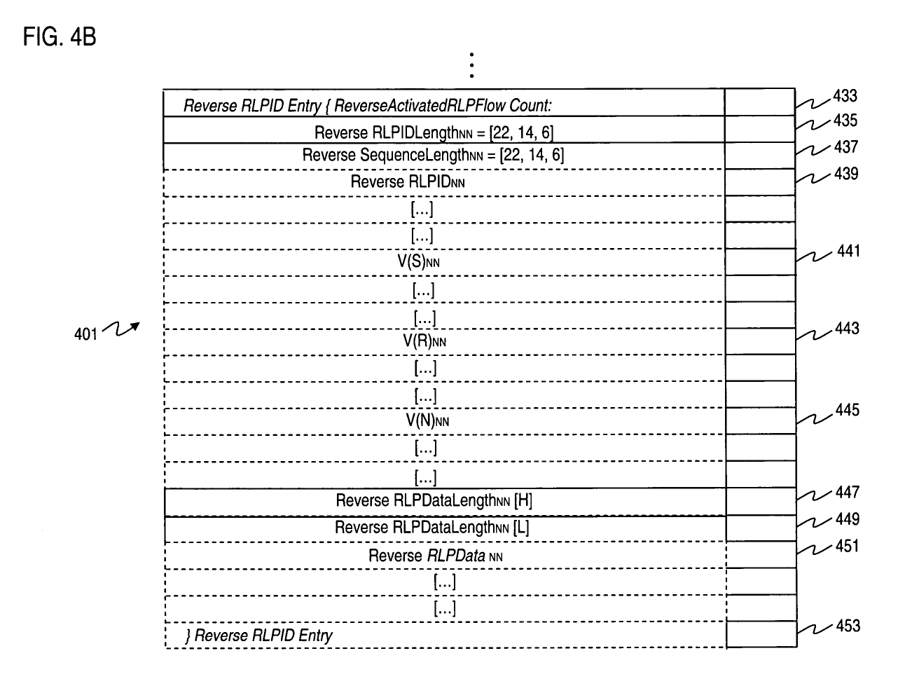

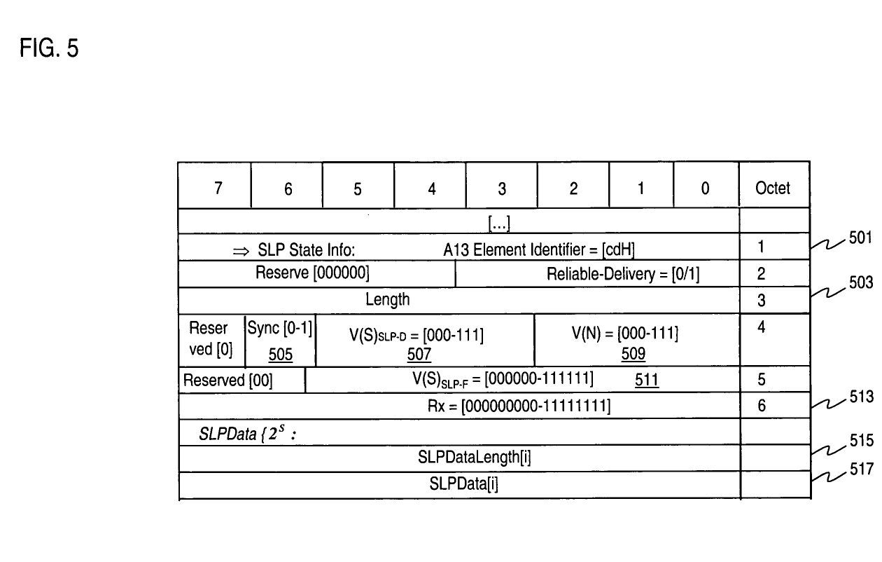

The RLP state information and the SLP state information, in one embodiment of the present invention, can be specified in a handoff request message, as more fully explained with respect to FIGS. 4A, 4B and 5.

FIG. 3 is a flowchart of a handoff process, in accordance with various embodiments of the present invention. In step 301, the AN 103 determines whether an active hard handoff has detected. Upon detection of the handoff, the source AN 103 transfers the state information 205 (of FIG. 2) and information data to the target AN 107 via the A13 interface (step 303). Thereafter the handoff process concludes and the target AN 107 processes the communication session, per steps 305 and 307.

FIGS. 4A and 4B are diagrams of a packet specifying RLP state information, in accordance with various embodiments of the present invention. By way of example, the RLP state information can be specified in an A13-Handoff Request Message 401 relating to the radio link protocol (RLP) state information.

TABLE 3

| INFORMATION | ELEMENT | | |
|---|---|---|---|
| ELEMENTS | DIRECTION | TYPE | |
| RLP State | Source--> | O | C |
| Information | Target | | |
| SLP State | Source--> | O | C |
| Information | Target | | |

It is noted that the RLP state information is included when the radio link protocol is not sending NAK (Negative Acknowledgements) messages for missing frames.

Table 4 enumerates the various fields in the A13-Handoff Request Message format of FIGS. 4A and 4B for RLP state information.

TABLE 4

| RADIO LINK PROTOCOL | |
|---|---|
| ELEMENTS (FIELD) | DESCRIPTION |
| A13 Element Identifier 403 | Indicates the type of message on the A13 |
| | interface |
| Length 405 | The number of octets in this element |
| | following the Length field 405 |
| Forward ActivatedRLPFlow | The number of forward ActivatedRLPFlow |
| Count 407 | Count RLP flows |
| Reverse ActivatedRLPFlow | The number of reverse ActivatedRLPFlow |
| Count 409 | Count RLP flows |
| Forward RLIID Entry; | Delimiter for start of Forward RLPID entry |
| Forward ActivatedRLPFlow | |
| Count 411 | |
| Forward RLPIDLength_{NN} | The length of forward RLPID of flow NN |
| 413 | |
| Reverse RLPIDLength_{NN} | The length of reverse RLPID of flow NN |
| 435 | |
| Forward SequenceLength_{NN} | The length of forward RLP sequence number |
| 415 | of flow NN |
| Forward RLPID_{NN} 417 | RLPID of forward RLP flow NN |
| Forward RLPID Entry 431 | Delimiter for end of Forward RLPID entry |
| V(S)_{NN} 419, 441 | Sequence number of the first octet of the next |
| | RLP packet to be sent, of the RLP flow NN |
| V(R)_{NN} 421, 443 | Sequence number of the first octet of the next |
| | RLP packet expected to be received, of the |
| | RLP flow NN |
| V(N)_{NN} 423, 445 | Sequence number of the first octet of the next RLP packet |
| | needed for sequential delivery, of the RLP flow NN |
| Forward RLPDataLength_{NN} | Number of Octet of forward RLP packets, of |
| [H] 425 | RLP flow NN, which were not transmitted |
| | before the handoff occurred |
| Forward RLPDataLength_{NN} | Number of Octet of forward RLP packets, of |
| [L] 427 | RLP flow NN, which were not transmitted |
| | before the handoff occurred |
| Reverse SequenceLength_{NN} | The length of reverse RLP sequence number |
| 437 | of flow NN |
| Reverse RLPID_{NN} 439 | RLPID of reverse RLP flow NN |
| Reverse RLPDataLength_{NN} | Number of Octet of reverse RLP packets, of |
| [H] 447 | RLP flow NN, which were not transmitted |
| | before the handoff occurred |
| Reverse RLPDataLength_{NN} | Number of Octet of forward RLP packets, of |
| [L] 449 | RLP flow NN, which were not transmitted |
| | before the handoff occurred |
| Reverse RLPData_{NN} 451 | Reverse RLPID packets, of RLP flow NN, |
| | which were not transmitted before the handoff |
| | occurred |
| Reverse RLPID Entry 453 | Delimiter for end of Reverse RLPID Entry |

FIG. 5 is a diagram of a message specifying SLP state information, in accordance with various embodiments of the present invention. Table 5 describes the fields of the message 501 conveying SLP state information.

TABLE 5

| SIGNALING LINK | |
|---|---|
| PROTOCOL ELEMENTS | |
| (FIELD) | DESCRIPTION |
| A13 Element Identifier 501 | Indicates the type of message on the A13 |
| | interface |
| Length 503 | This field indicates the number of octets in |
| | this element following the Length field |
| Sync 505 | Synchronized status flag for the SLP-F layer |
| V(S) SLP-D 507 | Sequence number of the next SLP-D packet |
| | to be sent |
| V(N) 509 | Sequence number of the next expected SLP- |
| | D packet |
| V(S) SLP-F 511 | Sequence number of the next SLP-F packet |
| | to be sent |
| Rx 513 | 8-bit (i.e., 2^{S} bit, where S=3) vector; |
| | Rx[i] = ‘1’if the |
| | SLP-D packet with sequence |
| | number i was received |
| SLPDataLength[i] 515 | Number of octet of SLP packet |
| SLPData[i] 517 | SLP packet |

The processes described advantageously provide fast handoff in a radio communication system. These processes can be executed through a variety of hardware and/or software configurations.

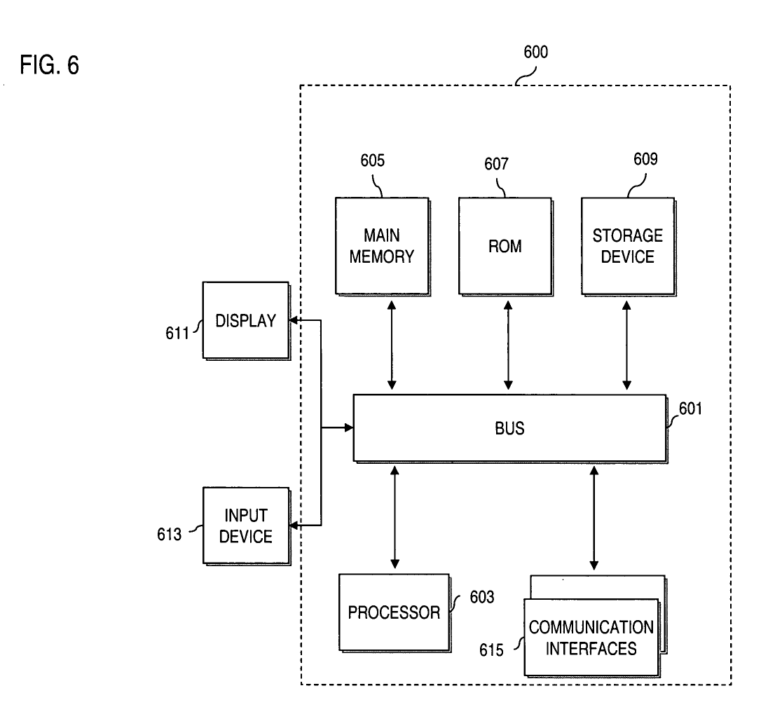

FIG. 6 illustrates exemplary hardware upon which an embodiment according to the present invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to one embodiment of the invention, the processes of FIGS. 2 and 3 can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method comprising:
detecting an active hard handoff condition associated with a communication session supported by a radio link protocol (RLP) flow and a signaling link protocol (SLP) flow; and
initiating transfer of state information of the RLP flow and the SLP flow over a pre-designated interface from a source entity to a target entity if an active hard handoff condition is detected.

2. A method according to claim 1, wherein each of the entities is either an access network or a packet control function.

3. A method according to claim 1, wherein the RLP flow includes a plurality of RLP packets, and the RLP state information includes a first sequence number corresponding to a first segment of a next RLP packet, a second sequence number corresponding to a next RLP packet to be received, and third sequence number corresponding to a next RLP packet needed for sequential delivery.

4. A method according to claim 1, wherein the RLP state information includes fields according to the following table:

| RADIO LINK PROTOCOL | |
|---|---|
| ELEMENTS (FIELD) | DESCRIPTION |
| A13 Element Identifier | Indicates the type of message on the A13 |
| | interface |
| Length | The number of octets in this element |
| | following the Length field 405 |
| Forward ActivatedRLPFlow | The number of forward ActivatedRLPFlow |
| Count | Count RLP flows |
| Reverse ActivatedRLPFlow | The number of reverse ActivatedRLPFlow |
| Count | Count RLP flows |
| Forward RLIID Entry; | Delimiter for start of Forward RLPID entry |
| Forward ActivatedRLPFlow | |
| Count | |
| Forward RLPIDLengthNN | The length of forward RLPID of flow NN |
| Reverse RLPIDLengthNN | The length of reverse RLPID of flow NN |
| Forward SequenceLengthNN | The length of forward RLP sequence number of flow NN |
| Forward RLPIDNN | RLPID of forward RLP flow NN |
| Forward RLPID Entry | Delimiter for end of Forward RLPID entry |
| V(S)NN | Sequence number of the first octet of the next |
| | RLP packet to be sent, of the RLP flow NN |
| V(R)NN | Sequence number of the first octet of the next |
| | RLP packet expected to be received, of the |
| | RLP flow NN |
| V(N)NN | Sequence number of the first octet of the next |
| | RLP packet needed for sequential delivery, of |
| | the RLP flow NN |
| Forward RLPDataLengthNN | Number of Octet of forward RLP packets, of |
| [H] | RLP flow NN, which were not transmitted |
| | before the handoff occurred |
| Forward RLPDataLengthNN | Number of Octet of forward RLP packets, of |
| [L] | RLP flow NN, which were not transmitted |
| | before the handoff occurred |
| Reverse SequenceLengthNN | The length of reverse RLP sequence number |
| | of flow NN |
| Reverse RLPIDNN | RLPID of reverse RLP flow NN |
| Reverse RLPDataLengthNN | Number of Octet of reverse RLP packets, of |
| [H] | RLP flow NN, which were not transmitted |
| | before the handoff occurred |
| Reverse RLPDataLengthNN | Number of Octet of forward RLP packets, of |
| [L] | RLP flow NN, which were not transmitted |
| | before the handoff occurred |
| Reverse RLPDataNN | Reverse RLPID packets, of RLP flow NN, |
| | which were not transmitted before the handoff |
| | occurred |
| Reverse RLPID Entry | Delimiter for end of Reverse RLPID Entry |

5. A method according to claim 1, wherein the SLP state information is associated with a delivery layer and a fragmentation layer.

6. A method according to claim 5, wherein the SLP state information includes a first sequence number of a next SLP packet associated with the delivery layer to be sent, a second sequence number of a next expected SLP packet associated with the delivery layer, a mapping vector of received SLP packets associated with the delivery layer, and a synchronization status flag associated with the fragmentation layer.

7. A method according to claim 5, wherein the SLP state information includes fields according to the following table:

| SIGNALING | |
|---|---|
| LINK PROTOCOL | |
| ELEMENTS | |
| (FIELD) | DESCRIPTION |
| A13 Element Identifier | Indicates the type of message on the A13 |
| | interface |
| Length | This field indicates the number of octets in |
| | this element following the Length field |
| Sync | Synchronized status flag for the SLP-F layer |
| V(S) SLP-D | Sequence number of the next SLP-D packet |
| (Delivery layer) | to be sent |
| V(N) | Sequence number of the next expected SLP- |
| | D packet |
| V(S) SLP-F | Sequence number of the next SLP-F packet |
| (Fragmentation layer) | to be sent |
| Rx | 8-bit (i.e., 2^{S} bit, where S=3) vector; Rx[i] = ‘1’ |
| | if the SLP-D packet with sequence |
| | number i was received |
| SLPDataLength[i] | Number of octet of SLP packet |
| SLPData[i] | SLP packet |

8. A method according to claim 1, wherein the pre-designated interface is an A13 interface.

9. A method according to claim 1, wherein a plurality of RLP flows are associated with the communication session, and the state information include state information of all of the RLP flows.

10. A computer-readable medium bearing instructions, being arranged, upon execution, to cause one or more processors to perform the method of claim 1.

11. A network apparatus comprising:
logic configured to detect an active hard handoff condition associated with a communication session supported by a radio link protocol (RLP) flow and a signaling link protocol (SLP) flow; and
a communication interface configured to transfer state information of the RLP flow and the SLP flow over a pre-designated interface from a source entity to a target entity if an active hard handoff condition is detected.

12. A network apparatus according to claim 11, wherein each of the entities is either an access network or a packet control function.

13. A network apparatus according to claim 11, wherein the RLP flow includes a plurality of RLP packets, and the RLP state information includes a first sequence number corresponding to a first segment of a next RLP packet, a second sequence number corresponding to a next RLP packet to be received, and third sequence number corresponding to a next RLP packet needed for sequential delivery.

14. A network apparatus according to claim 11, wherein the RLP state information includes fields according to the following table:

| RADIO LINK PROTOCOL | |
|---|---|
| ELEMENTS (FIELD) | DESCRIPTION |
| A13 Element Identifier | Indicates the type of message on the A13 |
| | interface |
| Length | The number of octets in this element |
| | following the Length field 405 |
| Forward ActivatedRLPFlow | The number of forward ActivatedRLPFlow |
| Count | Count RLP flows |
| Reverse ActivatedRLPFlow | The number of reverse ActivatedRLPFlow |
| Count | Count RLP flows |
| Forward RLIID Entry; | Delimiter for start of Forward RLPID entry |
| Forward ActivatedRLPFlow | |
| Count | |
| Forward RLPIDLength_{NN} | The length of forward RLPID of flow NN |
| Reverse RLPIDLength_{NN} | The length of reverse RLPID of flow NN |
| Forward SequenceLength_{NN} | The length of forward RLP sequence number of flow NN |
| Forward RLPID_{NN} | RLPID of forward RLP flow NN |
| Forward RLPID Entry | Delimiter for end of Forward RLPID entry |
| V(S)_{NN} | Sequence number of the first octet of the next |
| | RLP packet to be sent, of the RLP flow NN |
| V(R)_{NN} | Sequence number of the first octet of the next |
| | RLP packet expected to be received, of the |
| | RLP flow NN |
| V(N)_{NN} | Sequence number of the first octet of the next |
| | RLP packet needed for sequential delivery, of |
| | the RLP flow NN |
| Forward RLPDataLength_{NN} | Number of Octet of forward RLP packets, of |
| [H] | RLP flow NN, which were not transmitted |
| | before the handoff occurred |
| Forward RLPDataLength_{NN} | Number of Octet of forward RLP packets, of |
| [L] | RLP flow NN, which were not transmitted |
| | before the handoff occurred |
| Reverse SequenceLength_{NN} | The length of reverse RLP sequence number |
| | of flow NN |
| Reverse RLPID_{NN} | RLPID of reverse RLP flow NN |
| Reverse RLPDataLength_{NN} | Number of Octet of reverse RLP packets, of |
| [H] | RLP flow NN, which were not transmitted |
| | before the handoff occurred |
| Reverse RLPDataLength_{NN} | Number of Octet of forward RLP packets, of |
| [L] | RLP flow NN, which were not transmitted |
| | before the handoff occurred |
| Reverse RLPData_{NN} | Reverse RLPID packets, of RLP flow NN, |
| | which were not transmitted before the handoff |
| | occurred |
| Reverse RLPID Entry | Delimiter for end of Reverse RLPID Entry |

15. A network apparatus according to claim 11, wherein the SLP state information is associated with a delivery layer and a fragmentation layer.

16. A network apparatus according to claim 15, wherein the SLP state information includes a first sequence number of a next SLP packet associated with the delivery layer to be sent, a second sequence number of a next expected SLP packet associated with the delivery layer, a mapping vector of received SLP packets associated with the delivery layer, and a synchronization status flag associated with the fragmentation layer.

17. A network apparatus according to claim 15, wherein the SLP state information includes fields according to the following table:

| SIGNALING | |
|---|---|
| LINK PROTOCOL | |
| ELEMENTS | |
| (FIELD) | DESCRIPTION |
| A13 Element Identifier | Indicates the type of message on the A13 |
| | interface |
| Length | This field indicates the number of octets in |
| | this element following the Length field |
| Sync | Synchronized status flag for the SLP-F layer |
| V(S) SLP-D | Sequence number of the next SLP-D packet |
| (Delivery layer) | to be sent |
| V(N) | Sequence number of the next expected SLP- |
| | D packet |
| V(S) SLP-F | Sequence number of the next SLP-F packet |
| (Fragmentation layer) | to be sent |
| Rx | 8-bit (i.e., 2^{S} bit, where S=3) vector; Rx[i] = ‘1’ |
| | if the SLP-D packet with sequence |
| | number i was received |
| SLPDataLength[i] | Number of octet of SLP packet |
| SLPData[i] | SLP packet |

18. A network apparatus according to claim 11, wherein the pre-designated interface is an A13 interface.

19. A network apparatus according to claim 11, wherein a plurality of RLP flows are associated with the communication session, and the state information include state information of all of the RLP flows.

20. An apparatus comprising:
means for detecting an active hard handoff condition associated with a communication session supported by a radio link protocol (RLP) flow and a signaling link protocol (SLP) flow; and
means for initiating transfer of state information of the RLP flow and the SLP flow over a pre-designated interface from a source entity to a target entity if an active hard handoff condition is detected.

21. An apparatus according to claim 20, wherein each of the entities is either an access network or a packet control function.

22. An apparatus according to claim 20, wherein the RLP flow includes a plurality of RLP packets, and the RLP state information includes a first sequence number corresponding to a first segment of a next RLP packet, a second sequence number corresponding to a next RLP packet to be received, and third sequence number corresponding to a next RLP packet needed for sequential delivery.

23. An apparatus according to claim 20, wherein the RLP state information includes fields according to the following table:

| RADIO LINK PROTOCOL | |
|---|---|
| ELEMENTS (FIELD) | DESCRIPTION |
| A13 Element Identifier | Indicates the type of message on the A13 |
| | interface |
| Length | The number of octets in this element |
| | following the Length field 405 |
| Forward ActivatedRLPFlow | The number of forward ActivatedRLPFlow |
| Count | Count RLP flows |
| Reverse ActivatedRLPFlow | The number of reverse ActivatedRLPFlow |
| Count | Count RLP flows |
| Forward RLIID Entry; | Delimiter for start of Forward RLPID entry |
| Forward ActivatedRLPFlow | |
| Count | |
| Forward RLPIDLength_{NN} | The length of forward RLPID of flow NN |
| Reverse RLPIDLength_{NN} | The length of reverse RLPID of flow NN |
| Forward SequenceLength_{NN} | The length of forward RLP sequence number of flow NN |
| Forward RLPID_{NN} | RLPID of forward RLP flow NN |
| Forward RLPID Entry | Delimiter for end of Forward RLPID entry |
| V(S)_{NN} | Sequence number of the first octet of the next |
| | RLP packet to be sent, of the RLP flow NN |
| V(R)_{NN} | Sequence number of the first octet of the next |
| | RLP packet expected to be received, of the |
| | RLP flow NN |
| V(N)_{NN} | Sequence number of the first octet of the next |
| | RLP packet needed for sequential delivery, of |
| | the RLP flow NN |
| Forward RLPDataLength_{NN} | Number of Octet of forward RLP packets, of |
| [H] | RLP flow NN, which were not transmitted |
| | before the handoff occurred |
| Forward RLPDataLength_{NN} | Number of Octet of forward RLP packets, of |
| [L] | RLP flow NN, which were not transmitted |
| | before the handoff occurred |
| Reverse SequenceLength_{NN} | The length of reverse RLP sequence number |
| | of flow NN |
| Reverse RLPID_{NN} | RLPID of reverse RLP flow NN |
| Reverse RLPDataLength_{NN} | Number of Octet of reverse RLP packets, of |
| [H] | RLP flow NN, which were not transmitted |
| | before the handoff occurred |
| Reverse RLPDataLength_{NN} | Number of Octet of forward RLP packets, of |
| [L] | RLP flow NN, which were not transmitted |
| | before the handoff occurred |
| Reverse RLPData_{NN} | Reverse RLPID packets, of RLP flow NN, |
| | which were not transmitted before the handoff |
| | occurred |
| Reverse RLPID Entry | Delimiter for end of Reverse RLPID Entry |

24. An apparatus according to claim 20, wherein the SLP state information is associated with a delivery layer and a fragmentation layer.

25. An apparatus according to claim 24, wherein the SLP state information includes a first sequence number of a next SLP packet associated with the delivery layer to be sent, a second sequence number of a next expected SLP packet associated with the delivery layer, a mapping vector of received SLP packets associated with the delivery layer, and a synchronization status flag associated with the fragmentation layer.

26. An apparatus according to claim 24, wherein the SLP state information includes fields according to the following table:

| SIGNALING LINK | |
|---|---|
| PROTOCOL | |
| ELEMENTS | |
| (FIELD) | DESCRIPTION |
| A13 Element Identifier | Indicates the type of message on the A13 |
| | interface |
| Length | This field indicates the number of octets in |
| | this element following the Length field |
| Sync | Synchronized status flag for the SLP-F layer |
| V(S) SLP-D | Sequence number of the next SLP-D packet |
| (Delivery layer) | to be sent |
| V(N) | Sequence number of the next expected SLP- |
| | D packet |
| V(S) SLP-F | Sequence number of the next SLP-F packet |
| (Fragmentation | to be sent |
| layer) | |
| Rx | 8-bit (i.e., 2^{S} bit, where S = 3) vector; Rx[i] = ‘1’ |
| | if the SLP-D packet with sequence |
| | number i was received |
| SLPDataLength[i] | Number of octet of SLP packet |
| SLPData[i] | SLP packet |

27. An apparatus according to claim 20, wherein the pre-designated interface is an A13 interface.

28. An apparatus according to claim 20, wherein a plurality of RLP flows are associated with the communication session, and the state information include state information of all of the RLP flows.

29. A method comprising:
detecting an active hard handoff condition associated with a high rate packet data (HRPD) session supported by one or more radio link protocol (RLP) flows and one or more signaling link protocol (SLP) flows; and
initiating transfer of state information of the RLP flows and the SLP flows over an A13 interface to a target entity if an active hard handoff condition is detected.

30. A method according to claim 29, wherein the target entity is an access network or a packet control function.

31. A computer-readable medium bearing instructions, being arranged, upon execution, to cause one or more processors to perform the method of claim 29.
